(19) United States
(12) Patent Application Publication
(10) Pub. No.: US 2012/0119907 A1
(43) Pub. Date: May 17, 2012

(54) WARNING STANCHION

(76) Inventor: Joseph John TEUCHERT, Moores Hill, IN (US)

(21) Appl. No.: 13/293,765

(22) Filed: Nov. 10, 2011

Related U.S. Application Data
(60) Provisional application No. 61/412,616, filed on Nov. 11, 2010.

(51) Int. Cl. G08B 13/00; G08B 21/00

(52) U.S. Cl. 340/541; 340/689

(57) ABSTRACT

A warning stanchion that has a vertical support structure, a belt receptacle affixed to the vertical support structure, a tilt sensor, and a warning signal generator in communication with the belt receptacle and the tilt sensor. Typically, a plurality of the warning stanchions are used to created a warning barrier around an object so that the warning signal generates a signal when the warning barrier is breached. The warning signal generator may emit a visual warning, an audio warning, or a frequency signal.

### CROSS-REFERENCE TO RELATED APPLICATION

This application claims the benefit of U.S. Provisional Patent Application No. 61/412,616 filed on Nov. 11, 2010, the disclosure of which is incorporated herein by reference in its entirety.

### FIELD OF INVENTION

This invention relates generally to a warning stanchion and specifically to warning stanchions used for creating a barrier warning system to prevent vehicles from colliding with objects.

### BACKGROUND OF THE INVENTION

Airport ramps or aprons are active areas, with fuel, maintenance, baggage, and food service vehicles operating around a parked aircraft. Warning devices such as cones are used in airports to surround parked planes and warn approaching vehicles of the potential to collide with the plane. While such measures are sometimes effective, sometimes they are not, resulting in a collision with a plane. And when the current systems fail and a vehicle runs into a parked aircraft, damage occurs. Existing warning systems such as cones may fail because there is no active warning device associated with the cone, the vehicle driver does not see the cone, or a combination of both.

A warning system that warns a vehicle driver of a potential collision could further reduce the possibility of damage due to service vehicles colliding with parked airplanes.

### SUMMARY OF THE INVENTION

The invention relates to a warning stanchion comprising a vertical support structure, a belt receptacle affixed to the vertical support structure, a tilt sensor, and a warning signal generator in communication with the belt receptacle and the tilt sensor.

The invention further relates to a breach detection system comprising a first warning stanchion including a first vertical support structure, a first warning signal generator affixed to the first vertical support structure, and a first tilt sensor affixed to the first vertical support structure and communicating with the first warning signal generator, a second warning stanchion including a second vertical support structure, a second warning signal generator affixed to the second vertical support structure, and a second tilt sensor affixed to the second vertical support structure and communicating with the second warning signal generator, and a barrier communicating between the first warning stanchion and with the second warning stanchion.

This invention further relates to a method of warning of a breach of a protected area comprising identifying at least one boundary of a protected area, placing a plurality of warning stanchions along the at least one boundary of the protected area, wherein each warning stanchion has a vertical support structure, a warning signal generator affixed to the vertical support structure, and a tilt sensor affixed to the vertical support structure and communicating with the warning signal generator, establishing a barrier communicating between adjacent warning stanchions, and activating the warning signal generator of at least one of the warning stanchions upon detection of a barrier.

### BRIEF DESCRIPTION OF THE DRAWINGS

FIG. 1 is a perspective view of a plurality of the warning stanchions of the invention surrounding an object.

FIG. 2 is a perspective view of a plurality of the warning stanchions of the invention surrounding an airplane.

FIG. 3 is a perspective view of a warning stanchion of the invention showing various barrier belts.

FIG. 4 is another perspective view of a warning stanchion of the invention.

FIG. 5 is a perspective view two warning stanchions of the invention nested together.

FIG. 6 is a perspective view of a controller of the invention.

FIG. 7 is a functional diagram of one embodiment of the invention.

FIG. 8 is a more detailed functional diagram of the embodiment of the invention shown in FIG. 7.

FIG. 9 is a further detailed functional diagram of the embodiment of the invention shown in FIG. 7.

FIG. 10 is diagram of a user input keypad of the invention.

FIG. 11 is a perspective view of another embodiment of the invention.

### DETAILED DESCRIPTION OF THE INVENTION

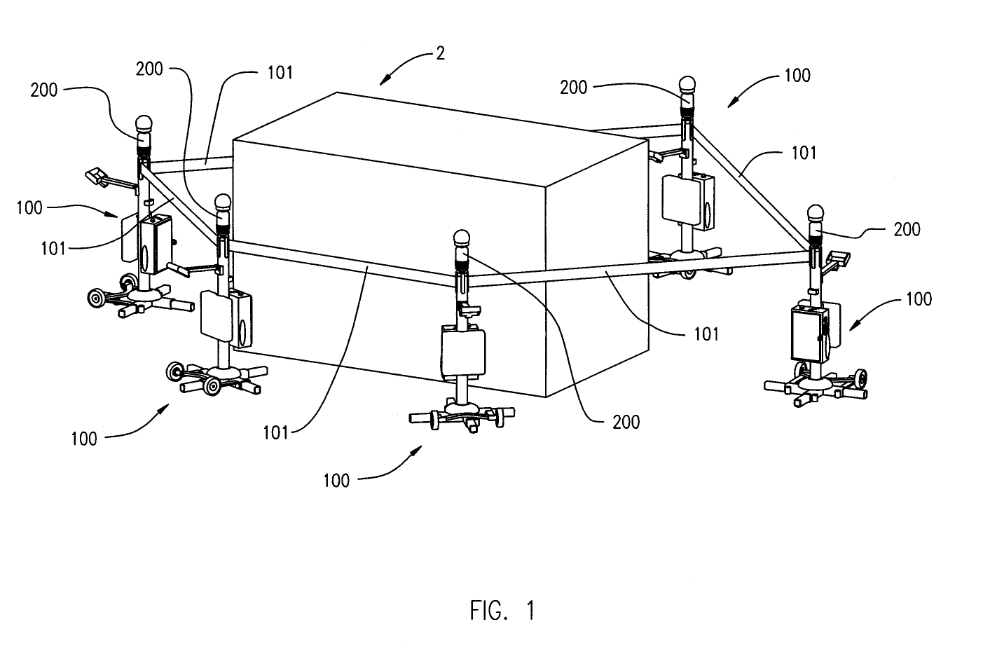

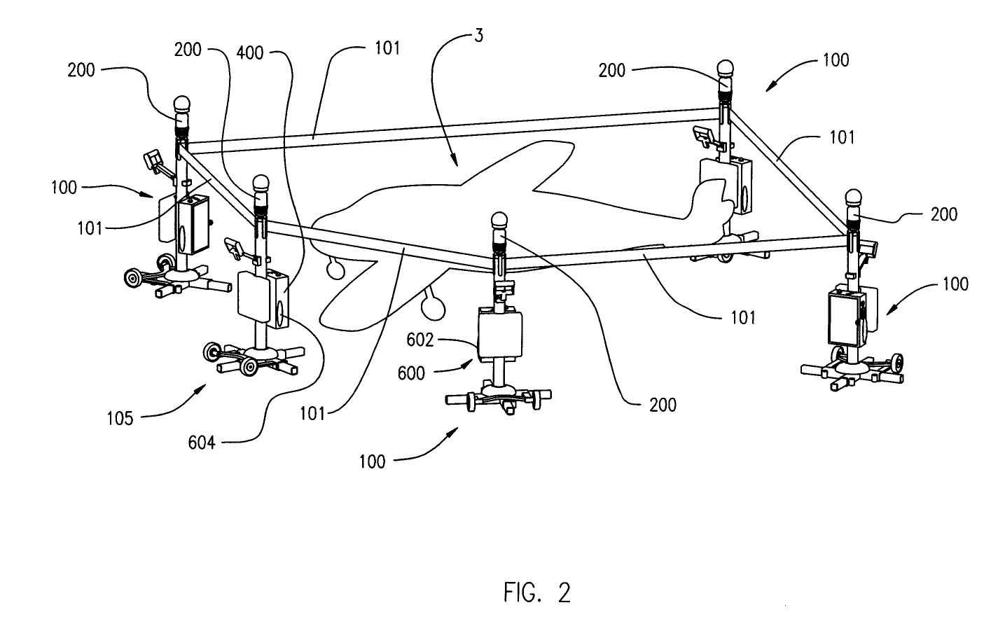

FIG. 1 shows a warning system having plurality of warning stanchions 100, each warning stanchion 100 stationed about at least a portion of the perimeter of an area surrounding an object 2 to warn a person that an approaching vehicles or other moving object of a breach of the perimeter and a potential collision with the object. Barrier elements 101 communicate between adjacent warning stanchions 100. If the moving vehicle or other moving object breaches one of the barriers 101, then at least one warning signal generating device 200 is activated. FIG. 2 shows the warning system having a plurality of warning stanchions 100 stationed about at least a portion of the perimeter of and area surrounding an airplane 3 (not to scale).

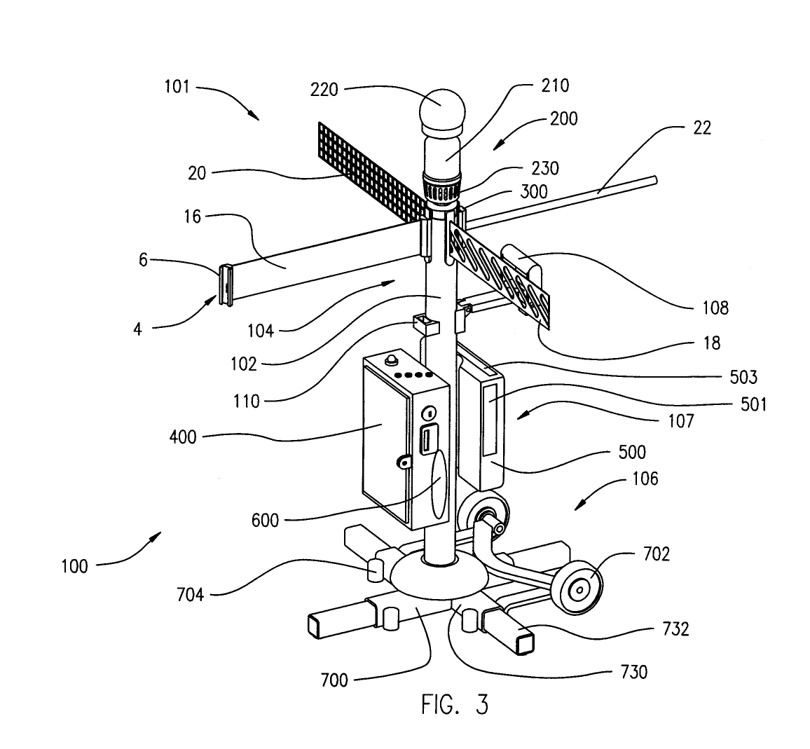

As shown in FIG. 3, the warning stanchion 100 includes a vertical support structure 102 having an upper section 104, a middle section 107, and a lower section 106. The upper section 104 includes a warning signal generator 200 and a barrier receptacle 300. The warning stanchion also includes a handle 108 and a handle receiver 110 approximately midway between the upper section 104 and the lower section 106. The lower section includes a controller 400, a power source 500, a barrier beam transmitter and barrier beam receiver 600, and a base portion 700. Other configurations are also possible. For example, each of the components, such as the warning signal generator 200, the barrier receptacle 300, the controller 400, power source 500, and barrier beam transmitter and barrier beam receiver 600, could be mounted anywhere on the warning stanchion, including on the lower section 106, the middle section 107, or the upper section 104.

The barriers 101 communicating between the warning stanchions 100 may take a variety of forms. The barrier shown in FIGS. 1-2 is a detecting barrier that can include an elongated webbed belt extending between two warning stanchions 100, or between the warning stanchion and another stanchion. Other types of elongated devices may also be used; for example, a wire cable, a rope, or a cord or cable having electrical conductors enclosed therein may also be used. The belt or other elongated device can detect a breach of the perimeter when a moving vehicle or object exerts a force laterally on the belt, which moves, stretches or elongates the belt between the one stanchion to the adjacent other stanchion.

Additionally, the barrier beam can include an electromagnetic or acoustic wave, including a laser light beam, infrared light beam, or other type of beam barrier, that is transmitted from and between a warning stanchion and another warning stanchion. The light beam, for example, is used to detect a breach of the perimeter when a moving vehicle or object passes between the two stanchions and breaks, or interrupts, the transmission of the light barrier from the one stanchion to the adjacent other stanchion.

Also, a tilt sensor can be used to detect a breach when a warning stanchion has been tilted from it's predetermined vertical stance, either by being struck directly by the moving vehicle of object, or by being pulled upon by a barrier belt when the moving vehicle or object exerts lateral force upon the barrier belt. The tilt sensor can include a foot sensor on the base portion of the warning stanchion, or an inclinometer mounted onto the vertical support structure.

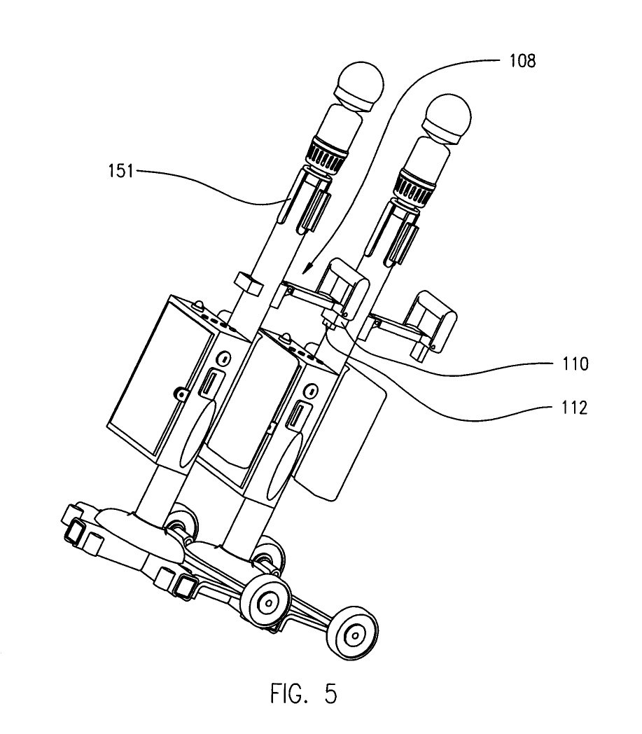

FIG. 3 shows a retractable belt barrier 101 affixed to a warning stanchion 100. A belt 4, webbing, or other material is wound around a reel (insert a patent publication that shows these details). The free end of the belt 4 is attached to a grip device 6. The belt may be a solid belt 16, a slotted belt 18, a perforated belt 20, or a cord 22. The slotted and perforated belts reduce buffeting during high winds. In use, the grip device 6 is held and is used to pull a length of the belt 4 off its reel against the action of a tensioning spring force. The grip device 6 can be pulled outwardly by hand to extend the belt 4 as needed or desired, and then secured to a corresponding holder 151 on an adjacent warning stanchion (FIG. 5). The holder 151 can be provided on a similar adjacent vertical support 102, on a wall, or on an existing structure. The extended belt 4 thereby provides a detecting barrier extending across a passageway or along a protected area for detecting moving objects or vehicles pushing against and breaching the belt barrier. Alternatively, the belt 4 may be arranged along the side of a pathway to define the pathway for guiding the passage of moving vehicles or people.

The retractable belt barrier shown in FIGS. 1-3 does not provide a physical barrier to the passage of the object. For example, where it is used to extend across a passageway it can only indicate that passage there through is barred, and can detect that a moving vehicle or object has moved against the belt. It is still possible for objects or vehicles to pass through the passageway, and either over, under, or through the belt. When passage of a moving vehicle or object is intended or permitted to pass across the perimeter, the grip device 6 can be unhooked from its holder and the belt 4 allowed to be rewound into the vertical support 102, or the grip device 6 could be temporarily unhooked and then refixed to the holder to enable a person to move around the belt 4, or one could simply cause more of the belt 4 to be drawn out of the vertical support 102 by pulling so that the belt can be moved (without triggering an alarm), and stepped over or driven over.

A sensor mechanism, such as a rotary encoder coupled with a reel on which the belt 4 is wound, can be housed within the belt receptacle 300. Great Britain Patent Application Number 9016535.8, filed Jul. 27, 1990 by Tensator Limited is incorporated by reference in its entirety into this Application. The rotary encoder comprises a rotary shaft which can be coupled directly to the reel of the belt if necessary. Additionally, the shaft can be extended by utilizing a shaft extender to couple the rotary shaft to the reel. The rotary shaft of the encoder is connected to, and arranged to rotate, a switching arm of the encoder. As it rotates, the switching arm moves over a plurality of circumferentially arranged, angularly spaced contact pads. In one embodiment, forty contact pads are provided around the circumference of the rotary encoder such that forty output pulses can be generated for a 360° rotation of the switching arm.

As the belt 4 is pulled out of, or retracted into the post, the switching arm of the encoder by way of the shaft will rotate. A direct current electrical supply is connected across the encoder and so a pulse train will be generated thereby. The number of pulses generated is dependent upon the angular rotation of the switching arm, and hence of the reel, and is independent of the direction of that rotation. Consequently, after a belt barrier is extended across a perimeter, secured to the adjacent warning stanchion, and “armed”, any object or vehicle moving laterally into contact with the belt will cause more of the belt to be extended and pulled from the reel, causing the switching arm to angularly rotate and generate a signal, which can initiate an alarm.

Another type of barrier that may be used to detect a breach is a beam barrier system. The beam barrier system would typically include a beam transmitting device and a beam detecting device. Beam barriers systems include systems for elitting and detecting electromagnetic radiation and acoustic waves, including lasers, infrared signals, microwave signals, radio frequency signals, and the like. The system is based on the photodetection of an emitted beam of light. The beam transmitting device 600 shown in FIG. 2 is a laser. A first stanchion 100 has a laser beam transmitter 602, and a second stanchion 105 has a laser beam detector 604. In operation, stanchions 100 and 105 are placed a distance apart and the line of radiation transmission of the laser transmitter 602 is aligned with receiving opening of the laser detector 604. Upon activation of the laser beam transmitter 602, the laser beam detector 604 detects the emitting laser beam (not shown) produced by the laser transmitter. An object passing in front of the laser beam breaks or interrupts the transmission of the laser beam to the laser beam detector, which interruption is detected by the laser beam detector, which sends a signal to the warning signal generator 200. The beam detector may send a signal directly to the warning signal generator, or it may send a signal to the warning signal generator through the controller 400. The beam barrier system may be used separate from or in conjunction with the retractable belt barrier.

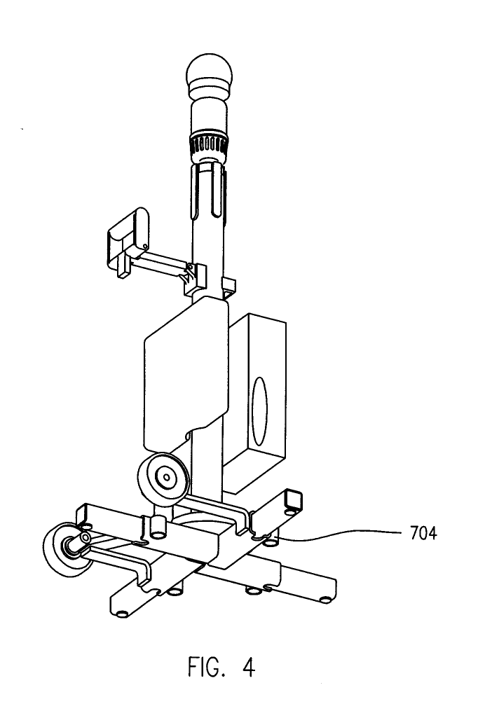

Another type of sensor that may be used to detect a breach is a tilt sensor that monitors the vertical alignment of a warning stanchion and sends a signal to the warning signal generator or the controller if the warning stanchion tips. The tilt sensor may be foot sensors 704, FIGS. 3-4, or it could be an inclinometer (not shown) included with the warning stanchion 100, which can detect when the warning stanchion has tilted over a predetermined angle from a reference position. The inclinometer also includes a processer for generating a signal when the tilting beyond the predetermined angle from reference has occurred. Examples of inclinometers include standard and MEMS inclinometers such as those that can be found at www.signalquest.com, www.usdigital.com, and www.riekerinc.com. When used in combination with a tilt sensor, the reel of the belt barrier is locked in place after the holder is affixed to an adjacent warning stanchion to prevent the belt from spooling out from the belt receptacle. The belt may be locked in place manually or automatically. For example, the belt receptacle may incorporate a manual locking mechanism or device that the operator utilizes to lock the belt reel. Additionally, the receptacle could contain an automatic locking mechanism that locks the belt reel once the belt has been deployed, or when a vehicle pushes on the belt, similar to a seat belt locking mechanism in a passenger motor vehicle. Alternatively, the operator may utilize the full length of the belt when connecting one stanchion to another, thereby eliminating any excess belting that otherwise could spool off of the receptacle. With the belt extended and locked in place, if a moving object pushes laterally on the belt, the belt pulls with force at the top of the adjacent warning stanchions, causing one or both of them to tilt, (as the warning stanchions can be configured to resist sliding along the base portion). The tilt sensors detect the tilting stanchion and send a signal of the barrier breach to the warning signal generator.

The warning signal generator may be arranged to generate a warning signal only in response to an output from a sensor which meets predetermined criteria. It is important for an alarm system to minimize false alarms to maintain the integrity of the system and to ensure that alarm conditions signaled are appropriately responded to by staff. An abnormal condition can arise, and the abnormal condition should not generate an alarm signal. For example, it is important that the alarm system discriminate between small movements of the belt barrier, caused by wind or by accidently brushing against the barrier, and actual alarm conditions as when a moving object is passing across the perimeter and against the belt barrier. When using tilt sensors to detect the tipping of the warning stanchion, the signal generator may only send a warning signal after the warning stanchion has been tipped for a predetermined amount of time, to a predetermined angle, or both. Additionally, when a beam barrier such as a laser is used, the signal generator may only send a warning signal after the barrier has been breached for a predetermined amount of time. Establishing a predetermined amount of time for the beam barrier to be breached before sending a warning signal prevents debris blowing across the barrier from creating a warning signal. Thus, the predetermined criteria set minimum response levels which have to be met in order that an alarm is generated. The warning signal generator may also allow adjustment of the predetermined criteria determining the conditions in which an alarm signal is generated.

The warning signal generator may comprise a delay circuit requiring that the breach condition persists for at least a minimum predetermined time before generating a warning signal. Also, the signal generator may comprise a threshold circuit requiring that the alarm condition exceed a predetermined minimum value before it generates a signal. For example, where the sensor is arranged to detect movement, movement in excess of a predetermined minimum distance can be required to occur for an alarm signal to be generated. Alternatively, instead of the warning signal generator, the controller may be used to assess if an actual alarm as required.

After receiving an output from a barrier or tilt sensor following a barrier breach, the warning signal generator 200 emits a warning signal to warn the operator of an approaching vehicle that it has breached the barrier system. The warning signal generator may include a visual warning device such as a strobe light or a rotating light, an audible frequency warning device, a frequency transmitter that generates a signal that is received by a remote device, any device that would generate a signal to warn an operator, or any combination of two or more of such devices. The remote device could be another warning device that generates an audio or visual warning signal such as a remote device located inside the cab of a vehicle, or it could be a device that interacts automatically with a breaching vehicle, for example by cutting power or applying the brakes to the vehicle.

The warning signal generator may generate multiple types of warning signals. For example, it may generate a visual warning, an audible warning, or a signal that is received by a remote warning device. Alternatively, instead of the warning signal generator, the controller may be used to generate a signal that is received by a remote warning device. The signal may be transmitted wirelessly or it may be transmitted through connectors such as wires or fiber optic cables.

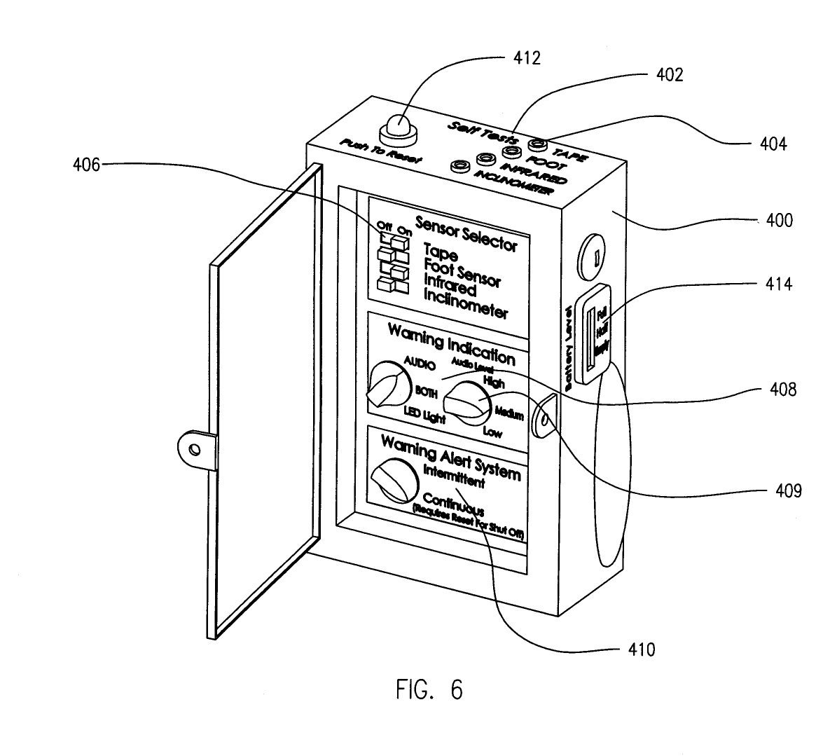

FIG. 6 shows one embodiment of a warning stanchion controller 400. The controller 400 includes elements to control operation of the warning system and elements to show an operator whether the system is operating properly, among others.

The controller 400 may include a solar charger or a trickle charger, or both, for recharging warning stanchion batteries, a battery containment box, a programmable controller for distinguishing between abnormal warning signals and actual warning conditions, and a signal generator for transmitting a signal to the warning signal generators indicating that an actual warning condition has occurred. The components may also include circuitry and controls for features communicating to external components of the controller. Those circuitry and control features may include a self test system, a reset button, sensor selectors, warning indications, warning alert conditions, and battery level indicators. A battery may also be included in the controller box.

A component of the controller 400 can include a self test indicator system 402. When an operator engages the self test system, the controller initiates a diagnostic test to assess whether certain components are functioning properly and are properly interconnected with other warning stanchions. For example, the self-test system may assess whether the barrier belts in a system are interconnected with each other, whether the inclinometers of each warning stanchion are functioning properly, whether the beam barriers are functioning properly, and whether the foot sensors are functioning properly. For example, the beam barriers are functioning properly if the emitted beam of light from the beam transmitting device 600 is detected confidently by the beam detector 604, and that the beam detector can generate a signal that is receivable by the warning signal generator 200. If the self test indicator system determines that a warning component is not functioning properly, then the self test indicator system generates a visual signal such as lights 404 to indicate to an operator which component is not functioning properly.

The controller can also have sensor selector switches 406 allowing the operator to select which type of warning system the operator wishes to employ. For example, the operator can choose to utilize any one or a combination of the belt sensor, the inclinometer, the foot sensor, or the beam barrier sensor, by manipulating the corresponding selector switches. In the illustrated embodiment, a toggle switch is used for each sensor, having an on and off switch position. The operator can select to use one of the warning systems, all of the warning systems, or any combination of the warning systems.

The controller can also include warning indicator switch 408, which allows an operator to select the type of warning indication desired. For example, in the illustrated embodiment, the operator can select a visual warning indication, an audio warning indication, a remote warning indication, or both. The controller can also include warning intensity switch 409 that allows the operator select the intensity, for example the audio level, of the warning signal. The remote warning indication would typically send a wireless signal that is then received by a remote warning device receiver located in the cab of a vehicle or at another remote location. The remote warning device sounds an audible alarm or presents a visual warning after receiving the wireless signal. The remote warning device receiver increases the likelihood that a vehicle operator is made aware of a breach of the barrier system despite the presence of ambient noise, whether that noise is audible noise such as jet engine noise, visual noise such as snow, rain or sleet, or other noise that would interfere with a vehicle operator hearing or seeing a warning signal produced by a warning signal generator located on a warning stanchion.

The controller may also have warning alert switches 410 that allow the operator to select the type of warning alert system desired. For instance, the operator may select an intermittent warning alert that will only allow a warning signal during the time the barrier is breached, or the operator may select a continuous warning alert that allows a continuous warning signal to be generated from the time the barrier is breached until the time an operator engages a reset button 412.

A visual battery level indicator 414 may also be incorporated into the controller to alert the operator of the charge status of the batteries that power the controller 400. The battery indicator can emit an audible warning, a visual warning, or both, in the event that the battery charge level drops below a predetermined level.

The controller can also include and internal clock and non-volatile memory for storing the time of events, including the arming and disarming of the system, the generation of any breach signals, and resetting of the system.

The warning stanchion may also include a camera 411 to record events occurring around the airplane, including a breach of the barrier. The camera can be fixed, can be programmed to turn toward the source of a breach, or may rotate and take continuous images or images only at intermittent times. To facilitate analysis of a barrier breach, the controller 400 may include a recording device that records data and images from the camera. The recording device may be an endless loop device that records over old unneeded data. For instance, the recorder may hold the prior ten hours of data at any one time. Thereafter, the recorder records over the oldest data. If an incident occurs that an operator desires to analyze, then the operator may download the data from the recorder to a storage device, or remove and preserve the recorder and replace it with a new recorder. Also, upon a breach of the barrier, the data recorder may recognize that a breach has occurred and save the data from the time period surrounding the breach for later review.

A warning system utilizes multiple warning stanchions. Each of these stanchions may include a controller 400. Alternatively, the system may include one master warning stanchion with a controller and additional subservient controllerless warning stanchions. If the system includes controllerless warning stanchions, then the subservient controllerless stanchions may be interconnected with the master warning stanchion so that the above described functions for all stanchions are performed by the master warning stanchion. In this case, each of the subservient warning stanchions can have a unique reference code that is embedded with any generated warning signals that are communicated to the master controller so that the location of the breach along the perimeter can be identified.

Power may be supplied to the warning stanchions by a variety of means. FIG. 3 shows an integrated power supply 500, including a rechargeable battery affixed to the warning stanchion. The battery may be recharged by an integrated solar panel 501, 503, or it may be recharged by plugging the warning stanchion into a hardwired power outlet. The warning stanchions typically communicate with each other, either physically via the belt barrier 4 or via the barrier beam, to create a perimeter barrier. Also, the belt barrier 4 or the alternative barrier material may include wires to transmit power to adjacent warning stanchions.

The warning stanchions may also communicate with each other. For example, communication may be desirable for the self test system or to signal the warning signal generators on all stanchions. The barrier may also include conductors to transmit signals from one warning stanchion to the other. For example, wires or fiber-optic cables may be integrated into the belt to transmit signals from one warning stanchion to another. Alternatively, the warning signal generator may create a wireless signal to alert the other warning stanchions of a barrier breach. Transmitting signals to additional warning stanchions is useful when one desires all warning stanchions to create a warning signal even when only one barrier is breached, thereby increasing the likelihood that the warning signal is noticed.

The base 700 of the warning stanchion 100 provides stability to the vertical support structure 102. As shown in FIG. 3, the base also includes wheels 702 to facilitate movement of the warning stanchion 100. The base may be round, square, or any other size and shape sufficient to support the stanchion. Additionally, the base 700 may be constructed with arms 730 that include extendable legs 732 that can be extended outward from the vertical support structure 102 to further enlarge the footprint of the base. Typically, the base is of a size sufficient and configuration to withstand 60 knot winds.

When two or more warning stanchions are connected together by way of belts 101 or beam barriers, the warning system provides a perimeter warning system that defines a protected area to warn vehicles of an impending collision with an aircraft. The system may be utilized to protect the entire perimeter of the aircraft or it may be utilized to protect a portion of the aircraft.

FIG. 5 shows how multiple stanchions may be nested together for storage and transport. The handle receiver 110 on one stanchion provides an opening that is sized to receive an extending portion 112 of the handle 108 of another stanchion. To facilitate transport of the stanchions, the handle receiver 110 of one stanchion may receive the extending portion 112 of the handle 108 of the second stanchion, thereby locking the stanchions together and allowing the one stanchion to be used to lift the second stanchion off of the ground. A third stanchion may be locked to the second stanchion the same way, and so on. With multiple stanchions locked together, an operator may utilize the handle 108 of the first stanchion to move multiple stanchions. Other methods of nesting the stanchions may also be used.

To establish a barrier warning system around the perimeter of an aircraft, an operator places the warning stanchions around the perimeter of the aircraft at appropriate locations. The operator then establishes the barrier between the adjacent stanchions by utilizing a belt barrier, a beam barrier, or both. The operator selects the type of barrier sensing desired utilizing the sensor selector switches, the type of warning indication desired using the warning indication switches, and the type of warning alert desired using the warning alert switches. The operator can then perform the self test and activate the system.

While this description discusses the barrier warning system in the context of protecting an airplane, barrier warning systems for protecting other objects are also envisioned. For example, the system could be used to protect stages, vehicles, construction sites, or any other objects or areas.

The stanchions are constructed of materials designed to withstand the environment in which they will be used. For example, when used in an airport, the warning stanchions and accompanying features might need to withstand sleet, snow, rain and ice in one region and humid tropical conditions in other regions. The stanchions can be designed to withstand all types of conditions.

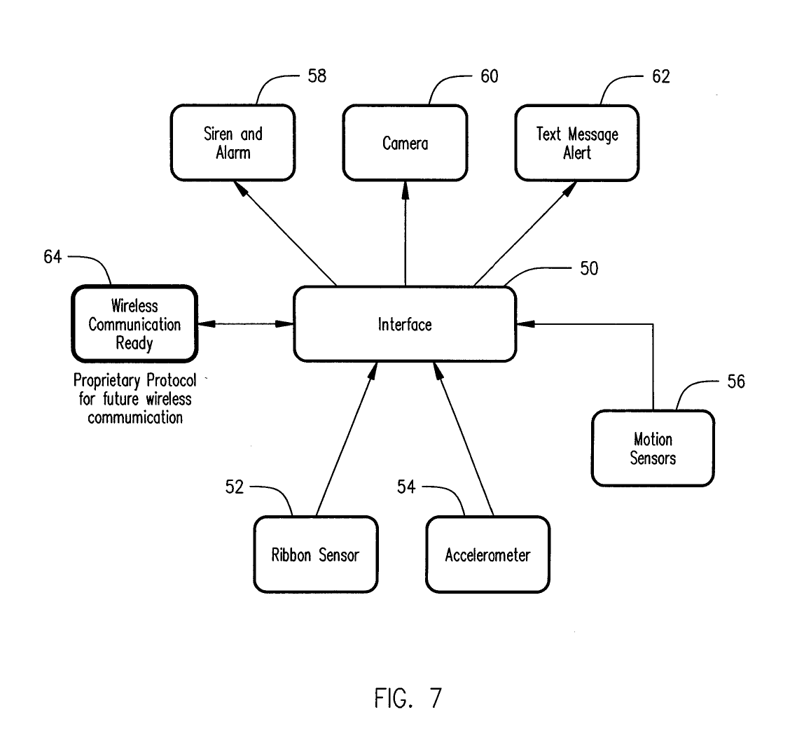

FIG. 7 shows a high level functional diagram of one embodiment of the warning stanchion. The interface 50, receives inputs from a ribbon sensor such as a sensor mechanism attached to a belt 52, an accelerometer 54, and motion sensors such as the beam barrier or tilt sensor 56. Based on a predetermined internal program and those inputs, the interface 50 may send out information to activate the siren and alarm 58, a camera 60, and a text message alert 62. The interface 50 may also communicate with other devices or persons by sending messages to and receiving messages from a wireless communication device 64.

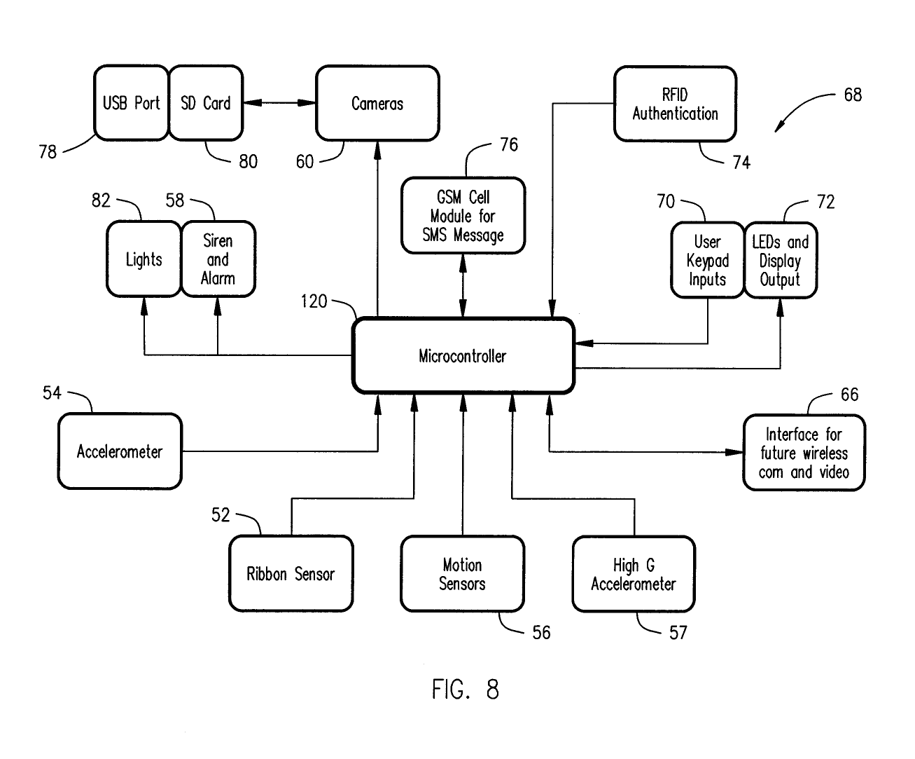

FIG. 8 shows a medium level functional diagram of one embodiment of the warning stanchion. A microcontroller 120 receives inputs from a ribbon sensor 52, an accelerometer 54, and a motion sensor 56. Also shown is a high G accelerometer 57. The high G accelerometer may be used to monitor for high impact events, such as a vehicle running into the warning stanchion at high speeds or someone dropping the warning stanchion, which can damage the warning stanchion. The high G accelerometer may be mounted in or on a controller 400 or at another suitable location on the warning stanchion. The microcontroller may store in a storage device high G events that exceed a certain threshold acceleration for later retrieval. Storage of high G events such as impacts may be useful in assessing whether a warranty claim for a damaged warning stanchion is covered or not. The microcontroller may also include an interface 66 for future wireless communication and video. A user interface 68 contains keypad and user input 70 and an output display 72, which can include LEDs, LCD, or other types of displays. Other inputs may also be included, such as an RFID authentication input 74 that may be used to require a user to authenticate their authority to operate the warning stanchion through the use of an RFID card.

The microcontroller may also communicate with a global system for mobile communications (“GSM”) cell module 76 for short message service (“SMS”) or text messaging. The microcontroller could use the GSM module to send out a text message to a predetermined list of people, typically managers, when a breach of a barrier is detected. The cameras 60 may also have a method of communicating with other devices through a USB port 78 or may have a storage device such as an SD card 80. The siren and alarm 58 may also include a warning light 82.

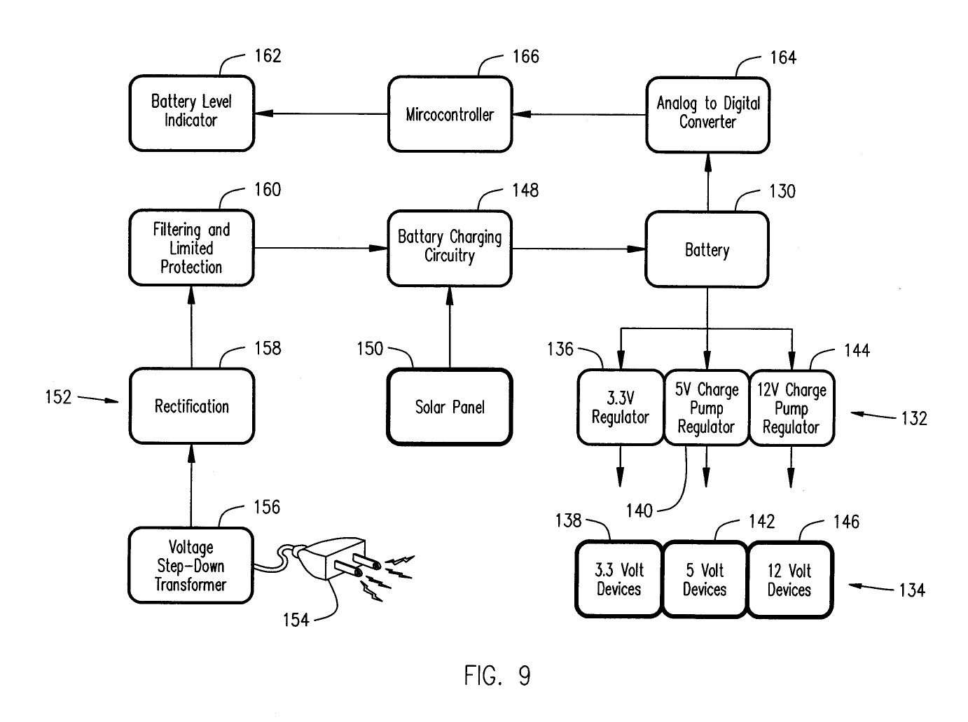

FIG. 9 shows one embodiment of a power supply system that may be used by the warning stanchion. A battery 130 provides power through power circuitry 132 to various devices 134. Depending on the devices used, the power circuitry 132 can include a 3.3 volt regulator 136 for powering 3.3 volt devices 138, a 5 volt charge pump regulator 140 for powering 5 volt devices 142, and a 12 volt charge pump regulator 144 for powering 12 volt devices 146.

The battery 130 can be charged by a variety of methods, including 120 volt AC and/or a solar panel, among others. The battery 130 is charged through battery charging circuitry 148 that conditions power from a solar panel 150 or from an AC charger 152. The AC charger 152 will typically include a plug 154 for connecting the AC charger to a mains power supply, a voltage step-down transformer 156 for reducing the voltage, a rectifier 158 for converting the AC power to DC power, and a filter and current limit protector 160 for cleaning the power and regulating the current supplied to the battery charging circuitry 148.

The power supply system also includes a battery level indicator 162. The battery level indicator 162 may use a column of LEDs, colored LEDs, a screen, or other types of display sources to indicate to a user the battery status. Typically, power from the battery is fed into an analog-to-digital converter 164 that feeds a microcontroller 166. The microcontroller 166 analyzes the digital signal from the analog-to-digital converter 164 and then sends a signal to the battery level indicator 162 to display the battery status.

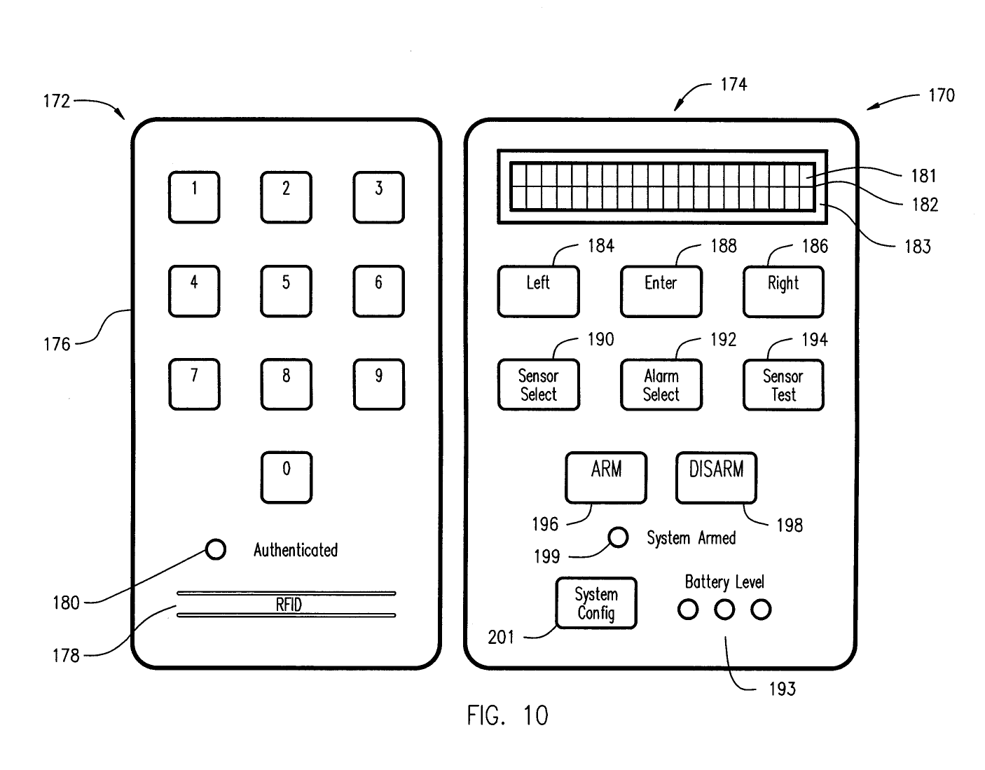

FIG. 10 shows an embodiment of a user interface 170. Functionally, the user interface 170 may be considered similar to the warning stanchion controller 400 described earlier and may also include the features described earlier for the warning stanchion controller and additional features. The user interface 170 has a user authentication device 172 and a configuration portion 174. While the user interface may be one of any of the types of interfaces such as number keypads, alpha-numeric keypads, soft-key keypads, an input device for receiving a password, a fingerprint or other biometric scanner, or an RFID reader, the interactive interface shown here is a membrane keypad. The user authentication device 172 is utilized to obtain authorization to activate the warning stanchion and to prevent unauthorized use of the warning stanchion and includes a keypad 176 and an RFID reader 178. To unlock the warning stanchion, a user may enter a password into the keypad 176 or may swipe a RFID card in front of the RFID reader 178. When a user is authenticated, an LED 180 will turn from red to green, indicating that the warning stanchion is unlocked and that the user may proceed to configure and activate the warning stanchion. Typically, the user authentication device 172 includes a timer that limits the time the warning stanchion is unlocked. For example, the warning stanchion may relock after a period of 1 minute, 2 minutes, 3 minutes, or any other period of time.

The configuration portion 174 of the interface includes a character display 182, which may include an upper display 181 and a lower display 183. A system configuration button 201 allows a user to select various features to enable, such as the RFID reader 178, the camera 60, or the text message alert 62. A left soft key 184, a right soft key 186, and an enter button 188 allow a user to navigate through a menu system and change functions. In operation, the upper display 181 will typically display a message and the lower display 183 will typically display two options the user can select. The left soft key 184 would select the left option and the right soft key 186 would select the right option. In other situations, setting the clock for example, the left button may increment hours and the right button may increment minutes. The enter button is typically required to exit the menu.

A sensor select button 190 allows the user to select the desired sensor using the left soft key 184 and the right soft key 186. For example, the user may select one or a combination of available sensors such as an accelerometer, ribbon barrier, or any other sensor that may be used with the warning stanchion. An alarm select button 192 allows the user to select the desired alarm using the left soft key 184 and the right soft key 186. For example, the user may select one or a combination of available alarms such as a siren, light, send text message, or other alarms that may be used with the warning stanchion. A sensor test button 194 allows a user to initiate a test of each of the connected sensors. Typically, a password is not required to perform a sensor test and the sensor test cannot be performed while the warning stanchion is armed. A timestamp of the sensor test may be recorded and saved to provide a record of the sensor tests.

After the system has been configured by the user for the desired sensors and alarms, then the user presses an arm button 196 to arm or activate the warning stanchion. Pressing a disarm button 198 will disarm, or deactivate, the warning stanchion. A LED system armed indicator light 199 will illuminate when the system is armed. A battery level indicator 193 may also be included. The battery level indicator may be LEDs, a LCD, or other display capable of showing the charge status of the battery. Typically, once a sensor is breached, the alarm will activate, and remain activated, until an authorized user enters a password or swipes a RFID card and either presses the arm button 196 to rearm the warning stanchion or presses the disarm button 198 to disarm the warning stanchion.

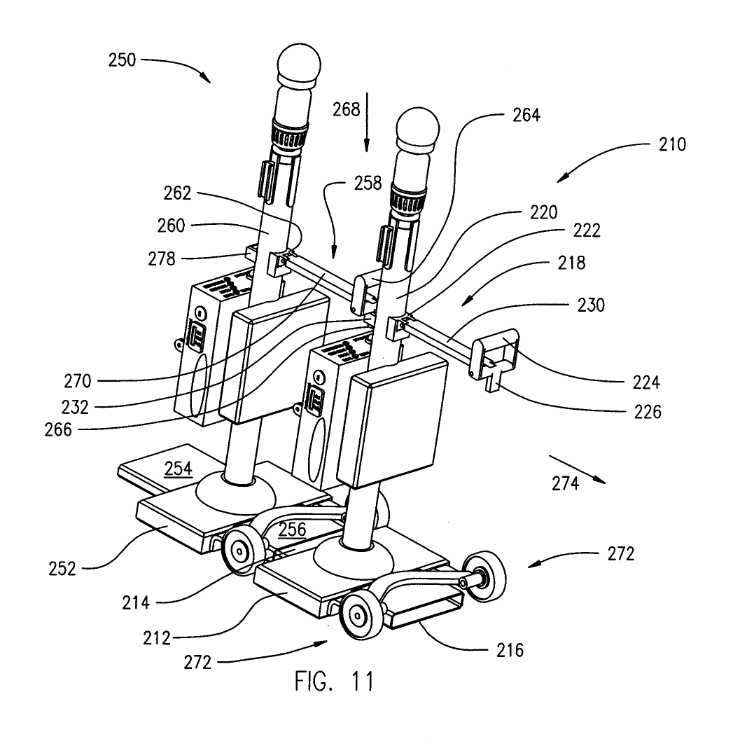

FIG. 11 shows another embodiment, a first warning stanchion 210. The warning stanchion 210 has a foldable arm 218 and a base 212 with a forward male section 214 and a rearward female section 216. The foldable arm 218 has a bar 230 and a handle 224 and is hingably mounted to a vertical support structure 220 with a hinge 222. The handle 224 includes a male connector 226. A female connector 232 is attached to the vertical support 220 opposite the hinge 222 and is sized to receive a male connector 266 of a handle 264 of a second warning stanchion 250, described below.

The second warning stanchion has a foldable arm 258 and a base 252 with a forward male section 254 and a rearward female section 256. The foldable arm 258 has a bar 270 and a handle 264 and is hingably mounted to a vertical support structure 260 with a hinge 262. The handle 264 includes male connector 266. A female connector 278 is attached to the vertical support 260 opposite the hinge 262 and is sized to receive a male connector of a handle 264 of another warning stanchion.

As shown in FIG. 11, multiple warning stanchions may be coupled for efficient transport. To connect one warning stanchion to another, the forward male section 214 of a first warning stanchion 210 is slid into the rearward female section 256 of a second warning stanchion 250. The foldable arm 258 is then moved downward in the direction of arrow 268 until the male section 266 of the second warning stanchion is engaged in the female section 232 of the first warning stanchion. The coupled warning stanchions can then be pivoted rearward about wheels 272 in the direction of arrow 274, causing the second stanchion 250 to pivot up and off the ground. The coupled stanchions can then be rolled on wheels 272.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A warning stanchion comprising:
a. a vertical support structure;
b. a belt receptacle affixed to the vertical support structure.
c. a tilt sensor, and
d. a warning signal generator in communication with the belt receptacle and the tilt sensor.

2. The warning stanchion according to claim 1, wherein the belt receptacle further comprises a belt and a sensor for sensing when the belt is being retracted or deployed.

3. The warning stanchion according to claim 1, wherein the warning signal generator is selected from the group consisting of a strobe light, a rotating light, an audible frequency generating device, and a frequency transmitter.

4. The warning stanchion according to claim 1, further comprising:
a. a controller for receiving a signal emitted from the belt receptacle and a signal emitted from the tilt sensor and sending a signal to the warning signal generator; and
b. a user interface communicating with the controller.

5. The warning stanchion according to claim 4, wherein the user interface comprises a user authentication device.

6. The warning stanchion according to claim 5, wherein the user authentication device is an RFID reader.

7. The warning stanchion according to claim 5, wherein the authentication device comprises an input device for receiving a password to activate the warning stanchion.

8. A breach detection system comprising:
a. a first warning stanchion including a first vertical support structure, a first warning signal generator affixed to the first vertical support structure, and a first tilt sensor affixed to the first vertical support structure and communicating with the first warning signal generator;
b. a second warning stanchion including a second vertical support structure, a second warning signal generator affixed to the second vertical support structure, and a second tilt sensor affixed to the second vertical support structure and communicating with the second warning signal generator; and
c. a barrier communicating between the first warning stanchion and with the second warning stanchion.

9. The breach detection system according to claim 8, wherein the barrier is a barrier selected from the group consisting of a belt, a wire cable, a rope, or a cable with conductors enclosed therein.

10. The breach detection system according to claim 8 wherein the barrier is a belt receptacle comprising a belt and a sensor mechanism for determining when the barrier is breached.

11. The breach detection system according to claim 10, further comprising:
a. a controller affixed to the first warning stanchion for receiving a signal emitted from the belt receptacle and a signal emitted from the tilt sensor, and sending a signal to the warning signal generator located on the first stanchion; and
b. a user interface communicating with the controller.

12. The breach detection system according to claim 11, wherein the user interface comprises a user authentication device.

13. The breach detection system according to claim 12, wherein the authentication device is an RFID reader.

14. The breach detection system according to claim 12, wherein the authentication device comprises an input device for receiving a password to activate the first warning stanchion.

15. A method of warning of a breach of a protected area comprising:
a. identifying at least one boundary of a protected area;
b. placing a plurality of warning stanchions intermittently along the at least one boundary of the protected area, wherein each warning stanchion has a vertical support structure, a warning signal generator affixed to the vertical support structure, and a tilt sensor affixed to the vertical support structure and communicating with the warning signal generator;
c. establishing a barrier communicating between adjacent warning stanchions; and
d. activating the warning signal generator of at least one of the warning stanchions upon detection of a breach of the barrier.

16. The method according to claim 15, wherein the activating step comprises obtaining authorization to arm the warning stanchion.

17. The method according to claim 16, wherein the obtaining authorization step comprises entering a password into a user interface.

18. The method according to claim 16, wherein the obtaining authorization step comprises passing an RFID card by an RFID reader associated with the warning stanchion.
